(19) United States
(12) Patent Application Publication
(10) Pub. No.: US 2023/0120070 A1
(43) Pub. Date: Apr. 20, 2023

(54) BELTPACK PAIRING SYSTEMS FOR USE WITH SPORTS TIMING AND DATA COLLECTION SYSTEMS AND METHODS OF USING

(71) Applicant: Michael Joseph Costabile, Shallotte, NC (US)

(72) Inventors: Michael Joseph Costabile, Oak Island, NC (US); Patrick Finnerty, Sunset Beach, NC (US); Dennis Brady Whitley, Cooleemee, NC (US)

(21) Appl. No.: 17/501,565

(22) Filed: Oct. 14, 2021

(51) Int. Cl. G07C 1/28; G04F 10/00

(52) U.S. Cl. CPC G07C 1/28; G04F 10/00

(57) ABSTRACT

A sports timing and data collection beltpack pairing system includes at least one beltpack emitting a unique identifier code and a base station configured to detect beltpacks emitting a matching specific alphanumeric code. The base station operator is presented with a list of compatible beltpacks and manually accepts specific beltpacks for use in a particular sports event. The beltpacks preferably have a fixed transmitter code including a payload having the manufacturer's code and manufacturer-assigned serial number.

### BACKGROUND OF THE INVENTION

The present invention relates generally to sports officiating systems, and more particularly, to beltpack pairing systems for use with sports timing and data collection systems and methods of use.

Many sports events are officiated by multiple officials, each of whom are outfitted with individual controllers that communicate with a central base station. These controllers can be very simple, for example each gymnastics judge in a panel may enter a contestant's score into a wired console that feeds the data to a central base station. These controllers can also be very sophisticated, for example wireless beltpacks that collect and transmit game, environmental and biometric data to a base station.

At least one inventor of the present invention has invented related advances in the field, as set forth in the following references below. These references are incorporated by reference in their entireties.
SPORTS MONITORING AND TRACKING SYSTEM described in U.S. Pat. No. 7,920,052 which issued Apr. 5, 2011 and pertains to specific signal generators, typically whistles, starting and stopping a game timer. This technology essentially negated the interference of background noise to allow specific game whistles to automatically activate the game timer.
SYSTEM FOR REMOTELY STARTING AND STOPPING A TIME CLOCK IN AN ENVIRONMENT HAVING A PLURALITY OF DISTINCT ACTIVATION SIGNALS described in U.S. Pat. No. 10,504,300 which issued Dec. 10, 2019 and pertains to starting and stopping a game clock with a variety of pre-identified whistles, and collecting data related thereto. This technology essentially improved the SPORTS MONITORING AND TRACKING SYSTEM invention by allowing referees to use their own whistles whose sonic fingerprints had been established, and collecting whistle blowing data on each referee based on those unique fingerprints.
SYSTEM AND METHOD FOR COLLECTING DATA IN A LIVE SPORTING EVENT described in PCT/US2020/027135 filed Apr. 8, 2020 pertains to communication bundles, hoop sensors and a time clock, all communicatively coupled and configured to collect environmental, biometric and game-related data during a game.
SONIC GENERATOR FOR USE WITH A TIMING AND DATA COLLECTION SYSTEM FOR A LIVE SPORTING EVENT described in U.S. application Ser. No. 17/333,784 filed May 8, 2020 pertains to a device that replaces a conventional whistle used in officiating sporting events.

Wireless beltpacks are especially useful in officiating games with highly mobile officials, for example basketball, football and hockey. However, for the system to work properly the beltpacks must reliably and securely communicate with the base station. This can be challenging due to the high electromagnetic interference and radio frequency interference found at sporting events. Moreover, RF transmissions can be vulnerable to malicious intrusion including spoofing, disruption and jamming.

FIG. 2 depicts a beltpack pairing system known in the art. In this system each beltpack includes a transmitter that is programmed to have a specific transmitter code. Typically this transmitter can be cleared and reprogrammed with a different transmitter code as desired. In preparation for a specific sporting event a base station is manually programmed to accept transmissions having specific transmitter codes that correlate with the beltpacks that are anticipated to be used in that sporting event. Prior to the sporting event the beltpacks are paired with the base station.

The system of the prior art is imperfect. For one, the process of programming beltpack transmitters with specific transmitter codes and programming base stations to accept transmission from beltpacks having those specific transmitter codes is labor intensive and must be performed by trained personnel. Also, once that programming is performed the specific combination of beltpacks with the base station is essentially set. This makes last minute changes, for example due to faulty or missing equipment, very problematic, especially in a sporting event environment where time is of the essence. Compromised security is another issue with known systems. Beltpacks often “walk away” and could wreak havoc on a game if in the wrong hands.

As can be seen, there is a need for beltpack pairing systems for use with sports timing and data collection systems and methods of use that are reliable and secure. The beltpack pairing systems are preferably easy to set up, economical, configured similarly to existing beltpacks so as not to confuse game officials, communicate effectively with its base station, and include features and options to effectuate improved officiating.

### SUMMARY OF THE INVENTION

A beltpack pairing system includes at least one beltpack and a base station for use in sports timing and data collection systems. Each beltpack emits a unique identifier code and the base station is configured to identify unique beltpacks based on their unique identifier code. Compatible beltpacks are identified in “discovery mode” which is initiated in the sports venue shortly before a sports event commences. The base station operator is presented with a list of compatible beltpacks detected during “discovery mode” and manually accepts specific beltpacks for use in a particular sports event. The beltpacks preferably have a fixed transmitter code including a payload having the manufacturer's code and the manufacturer-assigned serial number to ensure that each beltpack has a unique identifier.

### BRIEF DESCRIPTION OF THE DRAWINGS

FIG. 1 is a flowchart summarizing an embodiment of the present invention;

FIG. 2 is a flowchart generally depicting a beltpack pairing system of the prior art;

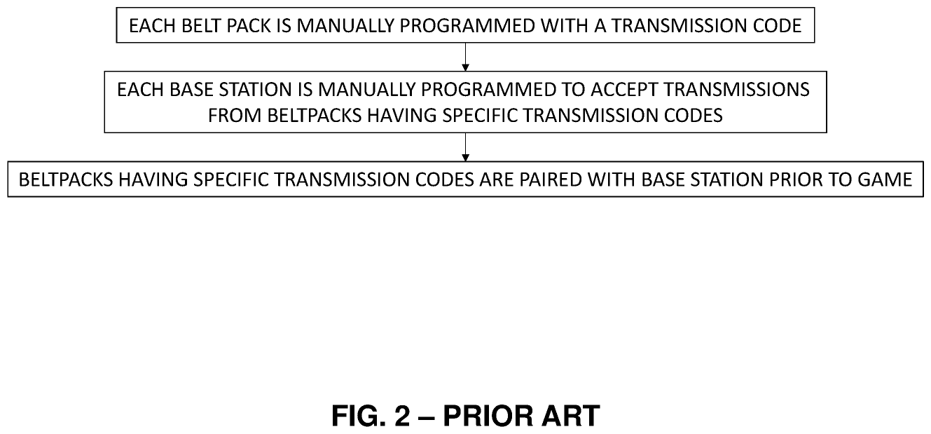

FIG. 3 schematically depicts a beltpack transmitting a transmitter code;

FIG. 4 schematically depicts a base station receiving transmitter codes from multiple transmitting devices; and

FIG. 5 schematically depicts multiple beltpacks transmitting their unique identifier codes to a base station.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The following structure numbers shall apply to the following structures among the various FIGS.:

10—Beltpack pairing system;

20—Unspecified transmitting device;

22—Preamble-specified transmitting device;

24—Payload-recognized transmitting device;

26—Unique beltpack;

28—Accepted beltpack;

30—Beltpack;

32—Printed circuit board;

33—Transmitter;

40—Base station;

42—Receiver;

50—Transmitter code;

60—Unique identifier code;

62—Preamble;

65—Payload;

66—Manufacturer's code;

67—Serial number; and

70—Base station operator.

Broadly, the present invention pertains to beltpack pairing systems used in sports timing and data collection systems and the related methods, and more particularly, to a system where each beltpack emits a unique identifier code and the base station is configured to identify unique beltpacks based on their unique identifier code, and to manually accept specific compatible beltpacks for use in a particular sports event.

As used herein, “beltpack” shall generally refer to a controller that communicatively links each official to a central base station at a sporting event. In the present invention the beltpack is preferably also communicatively coupled with the official's sonic signal generator, for example whistle, but beltpacks without this functionality are also within the scope of “beltpacks”. It should also be understood that a “beltpack” can be attached to a belt, affixed to an official's body or clothes, be handheld, hung from a lanyard, or otherwise, and that “beltpacks” are not limited to controllers secured at the waist.

As used herein, “pairing” and the like shall refer to the digital process by which pieces of equipment are communicatively coupled together in a cooperative system.

As used herein, a “transmitter code” is a radio frequency code that is emitted by a device. It can be fixed, for example a manufacturer's identification code, or it can be modifiable, for example a user selected security code.

As used herein “sports event venue” and the like shall refer to the location of a sports event such as a gymnasium, arena, coliseum, field or stadium.

As used herein, “sports timing and data collection systems” and the like shall refer to computerized systems that are used in sporting events to assist in scoring, timing, tracking official's whistle blows and calls, communicating with other game officials, and otherwise collecting situational data including game play, event environment including temperature and noise level, and biometric information on officials. In a preferred embodiment “sports timing and data collection systems” are from Precision Time, Inc. of Shallotte, N.C., but other systems are also within the scope of this invention.

For simplicity and clarity the present invention may be described in connection with basketball sporting events, but it should be understood that the present invention is not limited to basketball and could be used in a variety of sporting and recreational activities.

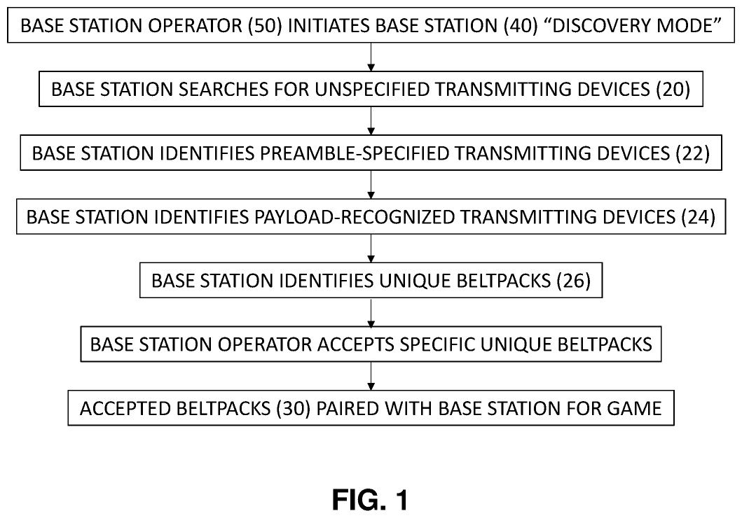

FIG. 1 summarizes a preferred beltpack pairing system for use with a sports timing and data collection system, and the method of use. Prior to the commencement of a sporting event, for example a basketball game, base station operator 70 initiates “discovery mode” on base station 40. This can occur offsite for shipping to a team, during game preparation several hours before tipoff, or even shortly before or during a game if a pack needs to be replaced. Discover mode typically requires less than 30 seconds.

During discovery mode the base station performs a screening protocol to distinguish beltpacks that will be used in the game from extraneous transmitting devices. This protocol is conceptually broken into four steps.

In the first step, base station 40 broadly searches for devices emitting a signal in the same frequency band as assigned to the base station. These devices are deemed unspecified transmitting devices 20.

In the second step, base station 40 analyzes the group of unspecified transmitting devices 20 to detect the devices transmitting a transmitter code with a specific preamble. These devices transmitting the proper preamble are deemed preamble-specified transmitting devices 22.

In the third step, base station 40 analyzes the group of preamble-specified transmitting devices 22 to detect the devices transmitting a transmitter code with a recognized payload. These devices transmitting the recognized payload are deemed payload-recognized transmitting devices 24.

In the fourth step, base station 40 identifies individual unique beltpacks 26 of the payload-recognized transmitting devices and provides base station operator 70 the opportunity to accept specific unique beltpacks 26 for use in the game. Those beltpacks that are accepted are classified as accepted beltpacks 28, paired to base station 40 and are ready for use in the sporting event.

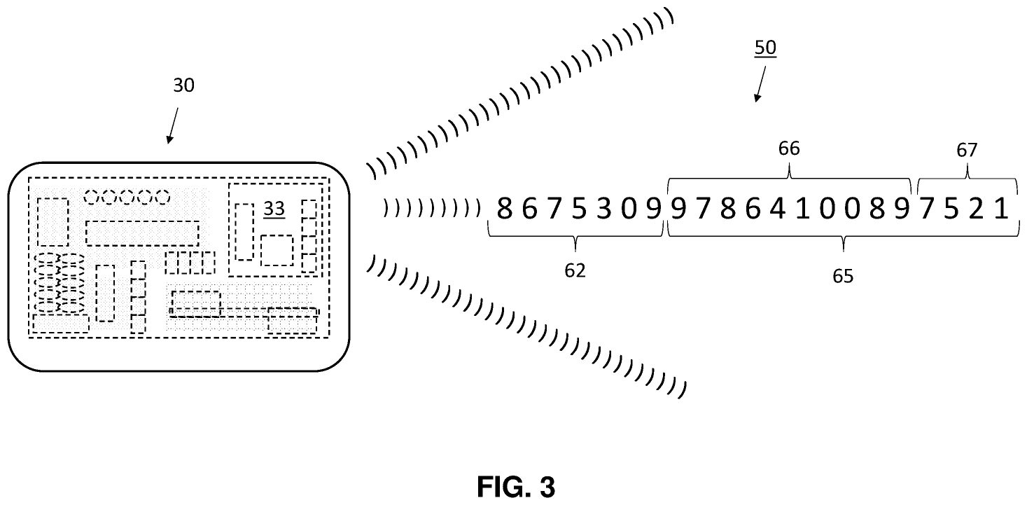

FIG. 3 schematically depicts beltpack 30 including transmitter 33 emitting transmitter code 50 including preamble 62 and payload 65. In a preferred embodiment payload 65 includes manufacturer's code 66 and serial number 67 thereby ensuring that every beltpack has a unique payload. The manufacturer's code and serial number are preferably assigned by the manufacturer and programmed into the transmitter by the manufacturer.

Transmitter 33 can emit fixed transmitter code 52, such as that described in the immediately preceding example, or emit modifiable transmitter code 53 which, as the name implies, can be modified by programming and reprogramming transmitter 33. The difference between transmitter code 50 and unique identifier code 60 is that a unique identifier code 60 is a transmitter code 50 emitted by unique beltpack 26.

It should be understood that a myriad of different alphanumeric transmitter code protocols, both conventional and new, as well as binary codes such as those from garage door openers, cell phones and cordless phones can be employed and are within the scope of this invention.

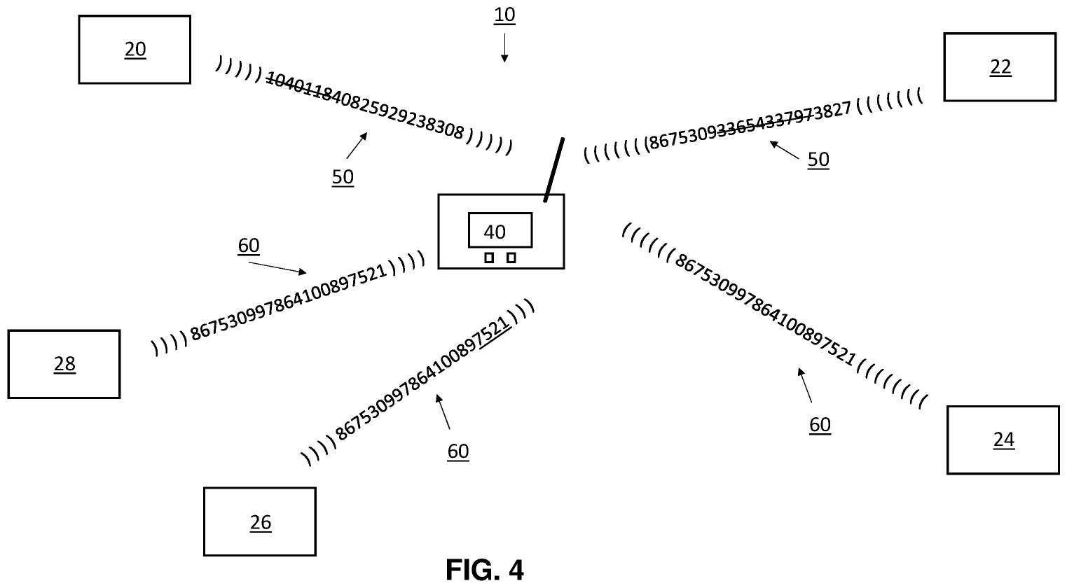

FIG. 4 schematically depicts how base station 40 in “discovery mode” receives and sorts through transmitter codes from multiple transmitting devices to identify potential devices for pairing and subsequent use. In this example the specified preamble 62 is 8675309 and manufacturer's code 66 is 9786410089.

Starting in the upper left corner and going clockwise, transmitter code 50 of unspecified transmitting device 20 has a non-specified preamble, shown here as 1040118, and therefore is excluded from further consideration.

Next, preamble-specified transmitting device 22 emits transmitter code 50 having the specified preamble of 1040118, but manufacturing code 3365433797 is unrecognized and therefore the device is excluded from further consideration.

Next, payload-recognized transmitting device 24 emits transmitter code 50 having both the specified preamble of 8675309 and manufacturer's code of 9786410089, thereby being recognized as a beltpack configured for use with the system.

Next, unique beltpack 26 is identified at base station 40 as having serial number 7521, and base station operator 70 (not shown) has option of accepting that unique beltpack.

Next, unique beltpack 26 has been accepted and is identified in base station as being accepted beltpack 28.

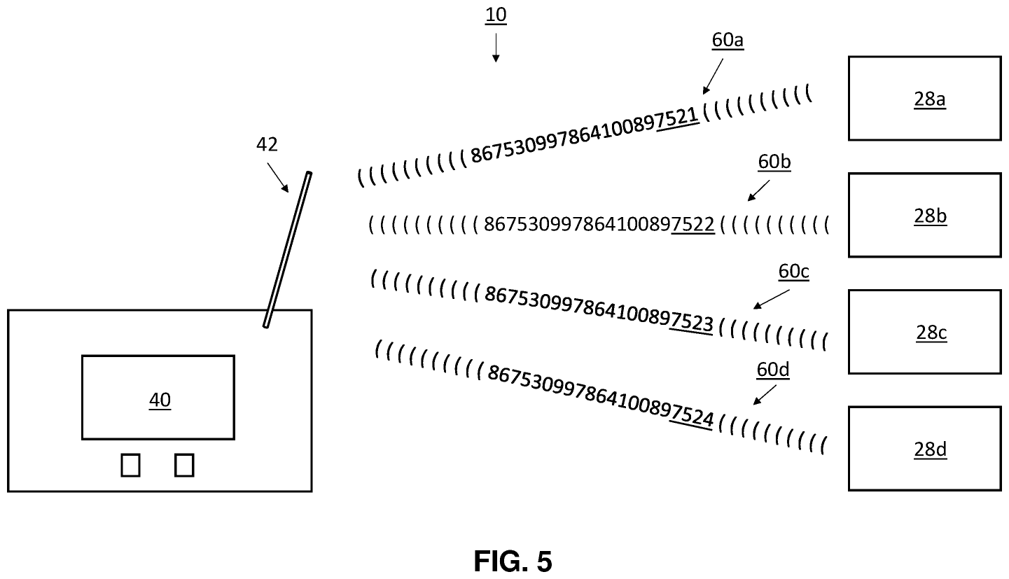

FIG. 5 depicts a plurality of accepted beltpacks 28a, 28b, 28c 28d, paired with base station 40 for use in a sporting event. Each beltpack has a unique identifier code 60.

In use, accepted beltpacks 28 are used by sports officials to perform a variety of functions including to detect when a specific whistle is blown; send a signal to the base station when a specific whistle is blown; start and stop the game clock; facilitate communication with other game officials; receive and/or send haptic audible or visual messages; measure environmental conditions such as noise level or temperature; and/or take biometric measurements of game official including heartrate and temperature.

Certain structures and components are disclosed for purposes of describing an embodiment, and setting forth the best mode, but should not be construed as teaching the only possible embodiment. Rather, modifications may be made without departing from the spirit and scope of the invention as set forth in the following claims. Examples of modifications include the inclusion of geolocation hardware and protocols that track the movement of the belt packs in the play area. It should be understood that all specifications, unless otherwise stated or contrary to common sense, are +/−10%, and that ranges of values set forth inherently include those values, as well as all increments between. Also, “substantially” as used herein, shall mean generally. By way of example a “substantially planar” surface includes surface imperfections but is generally planar.

What is claimed is:

1. A beltpack pairing system for use in officiating a sporting event including:
A) A first beltpack including a transmitter emitting a first unique identifier code; and
B) A base station configured to recognize said first beltpack based on said first unique identifier code, and to accept or reject said first beltpack for use in a specific sporting event based on input from a base station operator.

2. The beltpack pairing system of claim 1 wherein said first unique identifier code is a fixed transmitter code.

3. The beltpack pairing system of claim 2 wherein said fixed transmitter code includes a preamble and a payload.

4. The beltpack pairing system of claim 3 wherein said payload includes a manufacturer's code and a serial number.

5. The beltpack pairing system of claim 4 further including a second beltpack emitting a second unique identifier code, said second beltpack having a preamble and manufacturer's code identical to said first beltpack's preamble and manufacturer's code.

6. The beltpack pairing system of claim 5 wherein said second unique identifier code is different than said first unique identifier code.

7. A system for selecting beltpacks for use in officiating a sporting event including:
A) A plurality of unspecified transmitting devices including at least one beltpack emitting a unique identifier code; and
B) A base station configured to receive transmitter codes from said plurality of unspecified transmitting devices, wherein said base station distinguishes said at least one beltpack based on said unique identifier code from other unspecified transmitting devices in said plurality.

8. The system for selecting beltpacks of claim 7 wherein said plurality of unspecified transmitting devices includes cellphones, computers, computer networks and combinations thereof.

9. The system for selecting beltpacks of claim 7 wherein said base station is pre-programmed to identify a specific alphanumeric sequence corresponding with at least a portion of said unique identifier code.

10. The system for selecting beltpacks of claim 9 wherein said specific alphanumeric sequence corresponds with said unique identifier code in its entirety.

11. The system for selecting beltpacks of claim 7 wherein said at least one beltpack is configured to transmit a signal to said base station in response to recognizing a sonic signal from a sonic signal generator.

12. The system for selecting beltpacks of claim 11 wherein said signal to said base station causes a game clock to stop.

13. A method of pairing a beltpack with a base station for officiating a sporting event including the acts of:
A) Scanning for unspecified transmitting devices within a sports event venue for preamble-specified transmitting devices;
B) Identifying payload-recognized transmitting devices from said pre-amble specified transmitting devices;
C) Identifying unique beltpacks from said payload-recognized transmitting devices;
D) Accepting at least one of said unique beltpacks for use in a sporting event; and
E) Pairing said at least one unique beltpack to a base station, wherein said steps of scanning, identifying, accepting and pairing are performed by said base station.

14. The method of claim 13 wherein said step of pairing said at least one unique beltpack includes the step of pairing with at least one unique beltpack having a fixed transmitter code.

15. The method of claim 14 wherein said step of pairing with at least one unique beltpack having a fixed transmitter code includes the step of pairing with at least one unique beltpack having a fixed transmitter code including a manufacturer-assigned serial number.

16. The method of claim 13 wherein said step of pairing said at least one unique beltpack includes the step of pairing with at least one unique beltpack configured to transmit a signal to said base station in response to recognizing a sonic signal from a sonic signal generator.

17. The method of claim 16 wherein said step of pairing with at least one unique beltpack configured to transmit a signal to said base station in response to recognizing a sonic signal from a sonic signal generator includes the step of pairing with at least one unique beltpack configured to transmit a signal to said base station in response to recognizing a sonic signal from a sonic signal generator wherein said signal to said base station causes a game clock to stop.
